(19) United States
(12) Patent Application Publication
(10) Pub. No.: US 2004/0235574 A1
(43) Pub. Date: Nov. 25, 2004

(54) Automatic transmission input drum support ring and method

(76) Inventor: Fred Knox, Irvine, CA (US)

Correspondence Address: Karl M. Steins, Steins & Associates, Suite 120, 2333 Camino del Rio South, San Diego, CA, 92108, US

(21) Appl. No.: 10/441,528

(22) Filed: May 19, 2003

(51) Int. Cl. F16D 3/84

(52) U.S. Cl. 464/175

(57) ABSTRACT

An Automatic Transmission Input Drum Support Ring and Method is disclosed. Also disclosed is a support ring that is installable on the input drum of a conventional General Motors 700R4 automatic transmission in order to prevent overtorque-related cracking of this component. The device is configured to permit the transmission oiling/piston system to function as originally designed. The method for reinforcing a conventional transmission involves the installation of the support ring without the need for substantial modification of the conventional transmission.

### BACKGROUND OF THE INVENTION

1. Field of the Invention

This invention relates generally to transmission accessories and, more specifically, to an Automatic Transmission Input Drum Support Ring and Method.

2. Description of Related Art

The General Motors 700R4/4L60E automatic transmission is one of the most popular transmissions for use in performance-enhanced rear-wheel drive or four-wheel drive vehicles. Its popularity comes from its shift spacing, its wide cross-platform acceptance, and its lightweight design. Unfortunately, there has been one recurring problem associated with this transmission model, namely, the cracking of the input drum due to the input drum's inability to withstand the shaft torque created by performance engines. If not for the input drum cracking problem, the 700R4/4L60E transmission would be “unbreakable,” even in a performance vehicle drive train, since the rest of the transmission is extremely durable. The industry has recognized this problem and has attempted to cure it by replacing the entire casing of the input drum with a “beefed up,” more durable casing that allegedly can withstand more torque than the original equipment casing. There are two problems with this solution:

(1) the exchange of the entire input drum casing is fairly expensive and requires disassembly of a substantial portion of the transmission; and (2) while the torque handling capacity of the new casing is in excess of the original equipment, it still does not eliminate the problem, but only extends the durability somewhat. What is needed, then is a device and method to strengthen the original 700R4/4L60E transmission input drum substantially without necessitating a transmission rebuild, and at a fairly low cost.

### SUMMARY OF THE INVENTION

In light of the aforementioned problems associated with the prior devices and systems, it is an object of the present invention to provide an Automatic Transmission Input Drum Support Ring and Method. The support ring should be installable on the input drum of a conventional General Motors 700R4 automatic transmission in order to prevent overtorque-related cracking of this component. The device should be configured to permit the transmission oiling/piston system to function as originally designed. The method for reinforcing a conventional transmission should involve the installation of the support ring without the need for substantial modification of the conventional transmission.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a partially exploded side view of a conventional automatic transmission;

FIGS. 2A and 2B are end and side views of the sprocket assembly of the automatic transmission of FIG. 1;

FIG. 3 is a partial cutaway side view of the input shaft sleeve portion of the transmission of FIGS. 1 and 2;

FIGS. 4A and 4B are partial cutaway side views of the input shaft sleeve portion of the transmission of FIGS. 1-3 having the support ring device of the present invention installed thereon;

FIG. 5 is an end perspective view of the support ring device of FIG. 4; and

FIG. 6 is a cutaway side view of the support ring device of FIGS. 4 and 5.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide an. Automatic Transmission Input Drum Support Ring and Method.

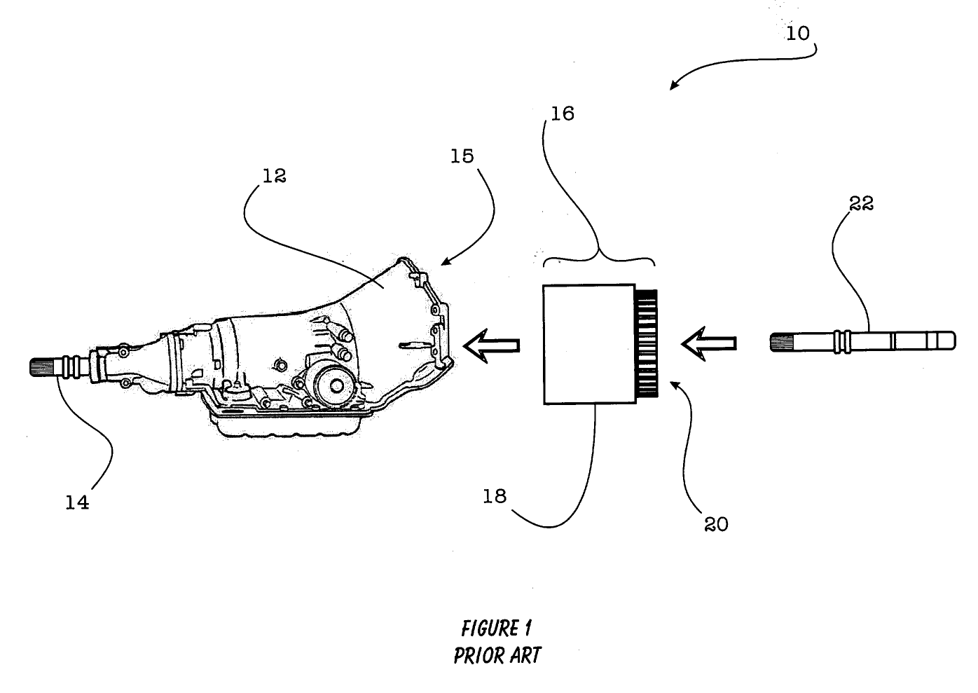

The present invention can best be understood by initial consideration of FIG. 1. FIG. 1 is a partially exploded side view of a conventional automatic transmission 10. The outer casing 12 contains a number of components, including bearings, clutch plates, shaft segments, etc.; only those components critical to understanding the present invention have been depicted here in the interest of simplicity and clarity.

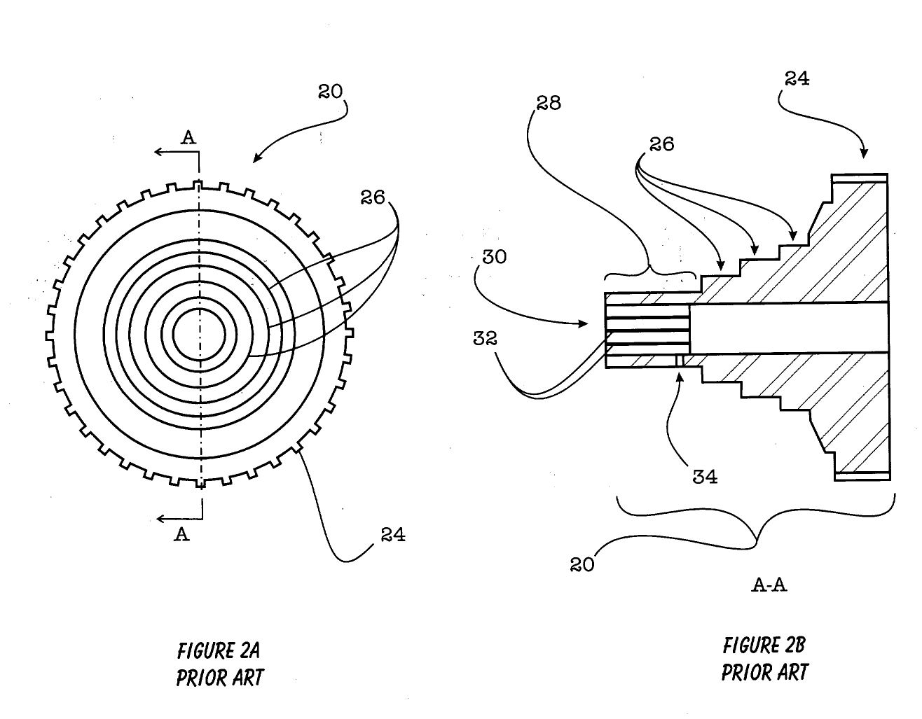

Extending from one end of the casing 12 is an output shaft 14, which is where the drive shaft and/or other mechanical components are attached to transmit power from the transmission 10 to the wheels. The input end 15 of the casing 12 is configured to attach to the engine itself. Shown here in an exploded view are the pertinent components to the advancement of the present invention. First is the input shaft 22, which is the actual power-takeoff connection to the engine. The input shaft 22 engages the sprocket assembly 20, which protrudes (to the right in this view) from the input drum casing 18. The sprocket assembly 20 and input drum casing 18 are integrated members that together comprise the assembly known as the input drum 16. When assembled, the input drum 16 is housed completely within the casing 12. Now turning to FIG. 2, we can examine the environment of the present invention more closely.

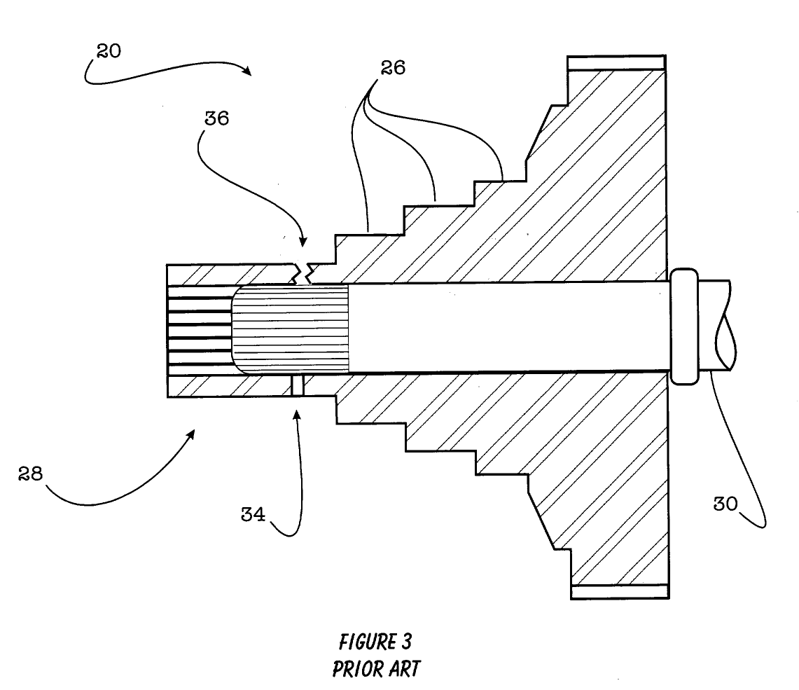

FIGS. 2A and 2B are end and side views of the sprocket assembly 20 of the automatic transmission of FIG. 1, absent the input drum casing (see FIG. 1) which has been eliminated in this view in the interest of simplicity. The sprocket assembly 20 is actually a single member having a gear or sprocket 24 at one end and a plurality of piston steps 26 at its other (input) end. When the transmission parts are completely assembled, the piston steps 26 serve as the inner surfaces of piston chambers that actually cause the transmission to operate (at least in part). The piston steps 26 gradually taper down until terminating at the overrun piston step 28. The overrun piston step has an input shaft bore 30 formed in it to accept the input shaft therein (see FIG. 1). The walls of the input shaft bore 30 have a plurality of splines 32 extending therefrom to engage corresponding splines extending outwardly from the input shaft (see FIG. 1). Just beyond the end of the splines 32 is located a oil passage 34 which permits hydraulic transmission fluid to pass between the interior and the exterior of the sprocket assembly 20 (i.e. the pistons). Turning to FIG. 3, we can examine exactly what problem the device and method of the present invention has been created to solve.

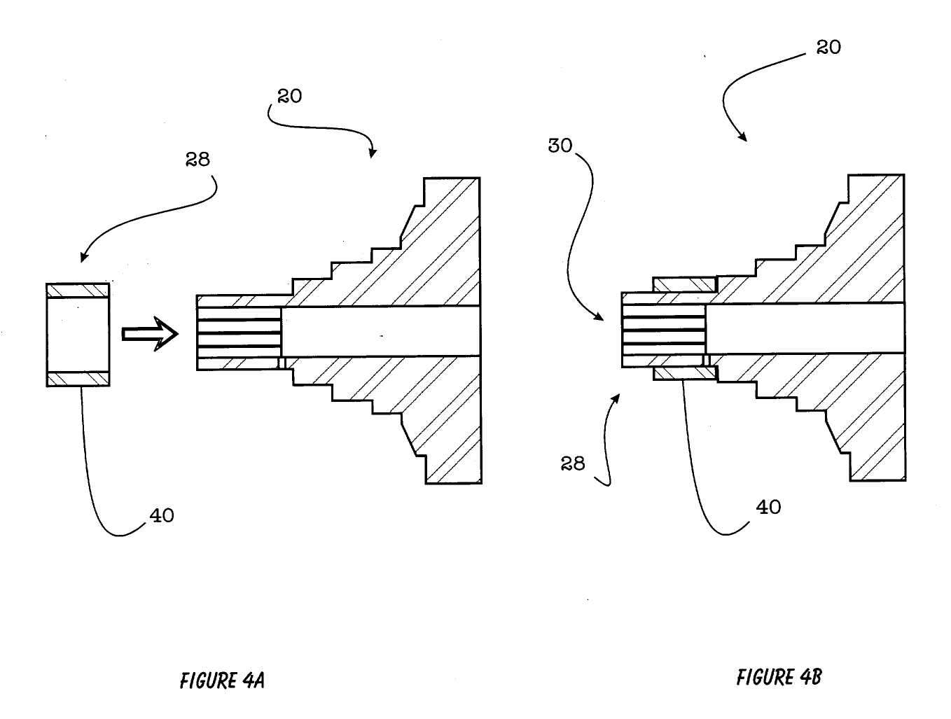

FIG. 3 is a partial cutaway side view of the sprocket assembly 20 of the transmission of FIGS. 1 and 2. As depicted here, the input shaft 30 has been inserted into the overrun piston step 28 of the sprocket assembly 20 such that the splines engage between the two. The problem with the 700R4/4L60E transmission is that cracks 36, such as the one shown here, have a tendency to develop when the input shaft is subjected to power in excess of 250 horsepower, or even under lower power conditions over prolonged periods of time. Once a crack 36 develops, the transmission must be rebuilt or replaced. In order to correct this problem, the invention described below commencing with FIG. 4 was developed.

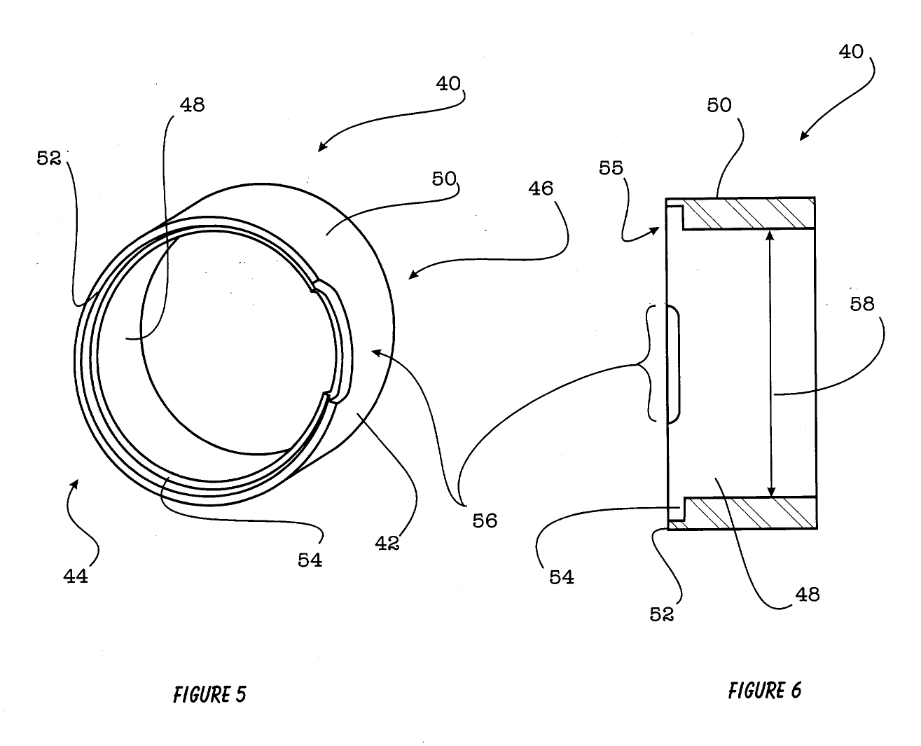

FIGS. 4A and 4B are partial cutaway side views of the sprocket assembly 20, and more specifically the overrun piston step 28 of the transmission of FIGS. 1-3 having the support ring device 40 of the present invention installed thereon. The device 40 is configured to be heated and pressed onto the overrun piston step 28 of the sprocket assembly 20. On cooling, an interference fit between the two elements that results in the support ring device 40 being held snugly thereto. Once the ring 40 is attached, the input shaft (see FIG. 3) can be inserted into the input shaft bore 30. The additional reinforcement resulting from the installation of the ring 40 strengthens the overrun piston step 28 substantially, without the need for expensive replacement drum assemblies. In fact, testing demonstrates that a transmission having undergone this modification enables it to withstand in excess of 400 horsepower without cracking the input shaft portion 28. It should be noted that the overrun piston (not shown) resides over the overrun piston step 28 when the transmission is fully assembled; the addition of the support ring device 40 will increase the diameter of the step 28, such that some modification to the overrun piston (not shown) will be necessary so that it might fit over both the overrun piston step 28 and the support ring device 40. Turning to FIGS. 5 and 6, we can examine further detail regarding the present invention.

FIG. 5 is an end perspective view of the support ring device 40 of FIG. 4. FIG. 6 is a cutaway side view of the support ring device 40 of FIGS. 4 and 5. The device 40 comprises a body 42 having a generally circular cross section. The body 42 further defines an a sprocket end 44 which is closest to the sprocket (see FIGS. 1-3) when installed on an input drum, and a shaft end 46 which is closest to the open end of the overrun piston step (see FIG. 4).

The body 42 further is defined by an outer surface 50 and an inner surface 48; as discussed above, the inner diameter 58 of the ring 40 is designed cooperatively with the outer diameter of the overrun piston step (see FIG. 4) to allow the ring 40 to slip over the overrun piston step when the ring is heated sufficiently, but yet to create an interference fit once the ring 40 has cooled.

The sprocket end 44 of the ring 40 defines an outer rim 52 and an inner rim 54; the inner rim 54 has a smaller outer diameter than the outer rim 52, such that a channel 55 is formed therebetween. Furthermore, a lubricating notch 56 is formed at the sprocket end 44 of the ring 40. When the ring 40 is installed onto a overrun piston step (see FIG. 4), the notch 56 is aligned with the oiling passage (see FIGS. 3 and 4) so that hydraulic fluid will not be obstructed by the ring 40 from flowing through the oiling passage. The channel 55 further aides in distributing hydraulic fluid around the circumference of the ring 40 as a safety measure in case the ring 40 begins to slip and a misalignment occurs between the notch 56 and the oiling passage (see FIGS. 3 and 4).

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A support device for an input drum of an automatic transmission defining a overrun piston step having an outer diameter, comprising:
a body defining a circular cross section and cooperatively designed to slip over said overrun piston step.

2. The support device of claim 1, defining a sprocket end and a shaft end, said sprocket end defining an outer rim and an inner rim.

3. The support device of claim 1, wherein said body further comprises at least one lubricating notch formed therein.

4. The support device of claim 1, wherein said body defines an inside diameter that is equal or less than said outer diameter of said overrun piston step.

5. The support device of claim 1, wherein said body further comprises a channel formed therein between an outer rim and an inner rim.

6. A method for reinforcing an automatic transmission input drum, said drum comprising a sprocket assembly having a overrun piston step, said overrun piston step defining an outside diameter, the method comprising the steps of:
pressing a support ring over said overrun piston step, said support ring comprising a body defining a circular cross section and cooperatively designed to slip over said overrun piston step.

7. The method of claim 6, wherein said pressing comprises pressing a support ring defining at least one lubricating notch formed therein.

8. The method of claim 7, wherein said pressing comprises pressing a support ring defining a sprocket end and a shaft end, said sprocket end defining an outer rim and an inner rim.

9. The method of claim 8, wherein said pressing comprises pressing a support ring defining an inside diameter that is equal or less than said outside diameter of said overrun piston step.

10. The method of claim 9, wherein said pressing comprises pressing a support ring wherein said body further comprises a channel formed therein between an outer rim and an inner rim.

11. A support device for an input drum of an automatic transmission including an input drum, said input drum defining a piston step having an outer diameter, comprising:
a body defining a circular cross section and cooperatively designed to slip over said piston step.

12. The support device of claim 11, defining a sprocket end and a shaft end, said sprocket end defining an outer rim and an inner rim.

13. The support device of claim 12, wherein said body further comprises at least one lubricating notch formed therein.

14. The support device of claim 13, wherein said body defines an inside diameter that is equal or less than said outer diameter of said piston step.

15. The support device of claim 14, wherein said body further comprises a channel formed therein between an outer rim and an inner rim.
